(19) United States
(12) Patent Application Publication
(10) Pub. No.: US 2024/0242306 A1
(43) Pub. Date: Jul. 18, 2024

(54) METHOD AND DEVICE FOR DISPLAYING APPLICATION ICON

(71) Applicant: ShangHai Qwik Smart Technology Co.,Ltd., Shanghai (CN)

(72) Inventor: Zhongquan SUN, Shanghai (CN)

(21) Appl. No.: 18/561,508

(22) PCT Filed: Jul. 9, 2021
(86) PCT No.: PCT/CN2021/105505

§ 371 Date: Nov. 16, 2023

(30) Foreign Application Priority Data
May 28, 2021 (CN) 202110589750.7

(51) Int. Cl. G06T 3/20; G06V 10/56; G06V 20/62

(52) U.S. Cl. CPC G06T 3/20; G06V 10/56; G06V 20/62; G06T 2200/24

(57) ABSTRACT

A method of displaying an application icon of an application program includes: in response to an activation of the application program, determining whether any important information or any human machine interface appears in a preset display region on a display interface; in response to the important information or the human machine interface being determined to appear in the preset display region, determining whether any important information or any human machine interface appears in a shifted display region on the display interface, and repeating the process of determining a presence of any important information or any human machine interface in the shifted display region until a target display region where neither important information nor human machine interface appears is determined in the display interface; and displaying the application icon of the application program in the target display region.

### CROSS-REFERENCE TO RELATED APPLICATION

This application claims priority to Chinese Patent Application No. 202110589750.7, filed with the China National Intellectual Property Administration (CNIPA) on May 28, 2021, the entire content of which is incorporated herein by reference.

### TECHNICAL FIELD

The present disclosure relates to the technical field of human machine interface display technology and, more particularly, to a method of displaying an application icon, a device for display the application icon, and a computer-readable storage medium.

### BACKGROUND

As the vehicle control technology constantly advances, an in-vehicle information system becomes more and more intelligent and capable of more and more configuration functions. As a result, a human machine interface between a user and the in-vehicle information system is becoming more and more complex. To facilitate the user to control various functions of a vehicle and to interact with the vehicle, voice control technology has been widely used in various in-vehicle information systems.

In the existing voice control technology, the in-vehicle information system usually displays an application icon of a voice function on a control display interface of the vehicle. The user clicks on the application icon to activate the voice function of the in-vehicle information system to perform human machine interaction functions such as vehicle control and data query through voice data. However, in the existing voice control technology, the application icon of the voice function is often displayed at a fixed position on a central control display interface in the form of a floating action button (hereinafter referred to as a floating icon), which is likely to block other control buttons and useful information thereunder, thereby affecting normal operations of the application icons (i.e., the control buttons), information display boxes, and other human machine interface functions.

To overcome the above-described issues in the prior art, a display technology of a human machine interface is urgently needed in this field. The display technology of the human machine interface can be used to automatically identify important information in the human machine interface and the human machine interface location to determine a proper display region, and to display the application icon in the proper display region, thereby ensuring the proper display of the important information in the human machine interface and the normal operation of the human machine interface.

### SUMMARY

A brief description of one or more aspects of the present disclosure is given below to provide a basic understanding of these aspects. The summary is not an exhaustive overview of all contemplated aspects and is not intended to identify key or critical elements of all aspects or to attempt to define the scope of any or all aspects. Its sole purpose is to present some concepts of one or more aspects in a simplified form as a prelude to the more detailed description that is presented later.

In order to overcome the deficiencies in the prior art, the present disclosure provides a method for displaying an application icon of an application program, a device for displaying the application icon of the application program, and a corresponding computer-readable storage medium, that can be used for automatically identifying objects in a human-computer interaction interface. The important information and the human machine interface are determined to determine the remaining displayable areas, and the application icon is displayed in the displayable areas to prevent them from affecting the important information in the human machine interface and the normal operation of the human machine interface.

One aspect of the present disclosure provides a method of displaying an application icon of an application program. The method includes: in response to an activation of the application program, determining whether any important information or any human machine interface appears in a preset display region on a display interface; in response to the important information or the human machine interface being determined to appear in the preset display region, determining whether any important information or any human machine interface appears in a shifted display region on the display interface, and repeating the process of determining a presence of any important information or any human machine interface in the shifted display region until a target display region where neither important information nor human machine interface appears is determined in the display interface; and displaying the application icon of the application program in the target display region. In the embodiments of the present disclosure, the method can automatically identify the important information in the human machine interface and the human machine interface to determine the remaining displayable areas, and display the application icon in the displayable areas to prevent them from affecting the important information in the human machine interface and the normal operation of human machine interface.

Another aspect of the present disclosure provides a device of displaying an application icon of an application program. The device includes a memory storing computer instructions and a processor coupled to the memory. The processor is configured to execute the computer instructions to: in response to an activation of the application program, determine whether any important information or any human machine interface appears in a preset display region on a display interface; in response to the important information or the human machine interface being determined to appear in the preset display region, determine whether any important information or any human machine interface appears in a shifted display region on the display interface, and repeat the process of determining a presence of any important information or any human machine interface in the shifted display region until a target display region where neither important information nor human machine interface appears is determined in the display interface; and display the application icon of the application program in the target display region. In the embodiments of the present disclosure, the device can automatically identify the important information in the human machine interface and the human machine interface to determine the remaining displayable areas, and display the application icon in the displayable areas to prevent them from affecting the important information in the human machine interface and the normal operation of human machine interface.

Another aspect of the present disclosure provides a computer-readable storage medium storing computer instructions. When being executed by a processor, the computer instructions cause the processor to perform: in response to an activation of an application program, determining whether any important information or any human machine interface appears in a preset display region on a display interface; in response to the important information or the human machine interface being determined to appear in the preset display region, determining whether any important information or any human machine interface appears in a shifted display region on the display interface, and repeating the process of determining a presence of any important information or any human machine interface in the shifted display region until a target display region where neither important information nor human machine interface appears is determined in the display interface; and displaying an application icon of the application program in the target display region. In the embodiments of the present disclosure, the instructions stored in the computer-readable storage medium can cause the processor to automatically identify the important information in the human machine interface and the human machine interface to determine the remaining displayable areas, and to display the application icon in the displayable areas to prevent them from affecting the important information in the human machine interface and the normal operation of human machine interface.

### BRIEF DESCRIPTION OF THE DRAWINGS

The above-described features and advantages of the present disclosure can be better understood through the detailed description of the embodiments of the present disclosure in conjunction with the accompanying drawings. In the drawings, components are not necessarily drawn to scale, and components with similar related properties or characteristics may have the same or similar reference numerals.

FIG. 1 is a flowchart of an exemplary method of displaying an application icon according to some embodiments of the present disclosure;

FIG. 2 is a schematic diagram of an initial interface displayed in a vehicle's central control display interface according to some embodiments of the present disclosure;

FIG. 3A is a schematic diagram of an application icon displayed in a preset display region according to some embodiments of the present disclosure;

FIG. 3B is a schematic diagram of a display region after a first adjustment according to some embodiments of the present disclosure;

FIG. 3C is a schematic diagram of a display region after a second adjustment according to some embodiments of the present disclosure;

FIG. 3D is a schematic diagram of an application icon displayed in a target display region according to some embodiments of the present disclosure; and

FIGS. 4A-4C are schematic diagrams of display region adjustments according to some embodiments of the present disclosure.

### DETAILED DESCRIPTION OF THE EMBODIMENTS

The embodiments of the present disclosure will be illustrated by various examples below, and those skilled in the art can easily understand other advantages and effects of the present disclosure from the description disclosed in the specification. Although the description of the disclosure will be presented in conjunction with preferred embodiments, it is not intended that the features of the disclosure be limited to these embodiments only. On the contrary, the objective of describing the disclosure in conjunction with the various embodiments is to cover other options or modifications that may be extended based on the claims of the present disclosure. The following description contains numerous details to provide a thorough understanding of the present disclosure. The disclosure may also be practiced without certain details. In addition, certain details may be omitted from the description to focus on key aspects of the present disclosure.

In the description of the present disclosure, it should be noted that unless otherwise specified and limited, the terms “installation”, “connection” and “connection” should be understood in a broad sense. For example, it may be a fixed connection, a detachable connection, or an integral connection. It may be a mechanical connection or an electrical connection. It may be a direct connection or an indirect connection through an intermediary, and it may be an internal connection between two components. Those of ordinary skill in the art can understand specific meanings of the above terms in the present disclosure in specific situations.

In addition, the terms “up”, “down”, “left”, “right”, “top”, “bottom”, “horizontal”, and “vertical” used in the following description should be understood as orientation shown in the accompanying drawings. The relative terms are used for convenience of description only, and do not imply that a device described therein must be manufactured or operated in a specific orientation, and thus should not be construed as limiting the present disclosure.

It should be understood that although the terms “first”, “second”, “third”, etc. may be used herein to describe various components, regions, layers and/or sections, these components, regions, layers and/or sections should not be limited by these terms, and these terms are merely used to distinguish different components, regions, layers and/or sections. Thus, a first component, region, layer and/or section discussed below could also be described as a second component, region, layer and/or section without departing from the scope of the embodiments of the present disclosure.

As described above, in the existing voice control technology, the application icon of the voice function is often displayed at a fixed position on the central control display interface in the form of a floating action button (hereinafter referred to as a floating icon), which is likely to block other control buttons and useful information thereunder, thereby affecting the normal operations of the control buttons, information display boxes, and other human machine interface functions.

To overcome the above-described issues in the prior art, the present disclosure provides a method of displaying an application icon, a device of displaying the application icon, and a corresponding computer-readable storage medium for automatically identifying important information and human machine interface arrangement to determine the proper display region, and displaying the application icon in the proper display region to ensure the normal operation of the important information in the human machine interface and the human machine interface arrangement.

In some embodiments, the method of displaying the application icon provided by the present disclosure may be implemented by the device of displaying the application icon provided by the present disclosure. Specifically, an application icon display device may include a memory and a processor. The storage includes, but is not limited to, the computer-readable storage medium provided by the present disclosure, on which computer instructions are stored. The processor is coupled to the memory and is configured to execute the computer instructions stored on the memory to implement the method of displaying the application icon provided by the present disclosure.

Operation principle of the application icon display device will be described below in conjunction with some embodiments of an application icon display method. Those skilled in the art can understand that the application icon display method is merely some embodiments provided by the present disclosure, and is intended to clearly demonstrate the idea of the present disclosure and to provide some specific solutions that are convenient for the public to implement, rather than restricting all operation modes and all functions of the above-described application icon display device. In contrast, the device of displaying the application icon is merely some embodiments provided by the present disclosure, and does not limit performers of the above-described method of displaying the application icon.

In some embodiments, the device of displaying the application icon may be embedded in a vehicle controller (Vehicle Control Unit, VCU) and/or other vehicle control modules of the in-vehicle information system in the form of program codes or application programs. The application programs include but are not limited to voice control programs, map navigation programs, and other application programs with floating application icons installed on the display device. The user can operate the display device to start the application program, such that the application icon of the application program is displayed in the form of a floating icon on the vehicle's central control display interface, and one or more functions of the application program are performed by clicking the application icon.

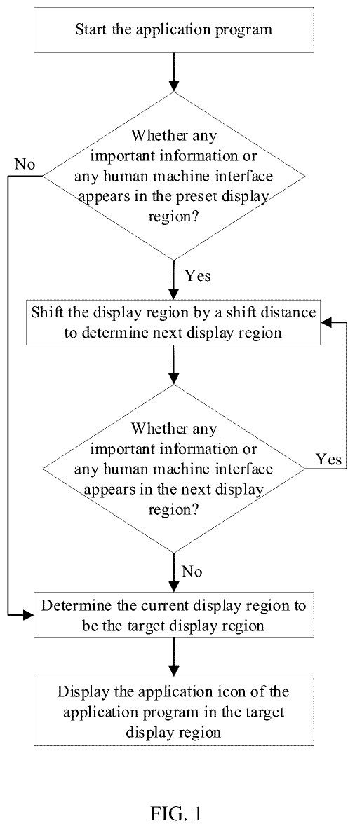

FIG. 1 is a flowchart of an exemplary method of displaying an application icon according to some embodiments of the present disclosure.

As shown in FIG. 1, in some embodiments, the in-vehicle information system may automatically start vehicle's voice control program in response to the vehicle being powered on, so as to activate vehicle's voice control function. The voice control program may run in the background of the in-vehicle information system, and only a voice icon is displayed on the vehicle's central control display interface for the user to control the in-vehicle system to collect voice data.

Specifically, in response to the activation of the vehicle's voice control program, the application icon display device may obtain a preset location information and a preset shape information from the vehicle's voice control program, to determine a preset display region in the vehicle's central control display interface for displaying the voice icon. It should be understood that the preset location information may be set by a designer of the vehicle's voice control program based on experience, and the preset shape information should conform to a shape of the voice icon, such that the preset display region is sufficient to accommodate the voice icon.

Further, the application icon display device determines whether any important information or any human machine interface appears in the preset display region of the vehicle's central control display interface according to a coordinate range of the preset display region, and uses determination result to further determine whether the preset display region needs to be horizontally (or vertically) shifted to avoid the important information and the human machine interface in the central control display interface. In some other embodiments, the preset display region may be shifted in another direction other than the horizontal direction or the vertical direction. For illustration purpose, the preset display region is described as being shifted in the horizontal direction and/or the vertical direction. In some embodiments, the determination of the important information may be implemented based on character recognition technology and/or image recognition technology, and the determination of the human machine interface may be implemented based on a tree structure of the in-vehicle information system.

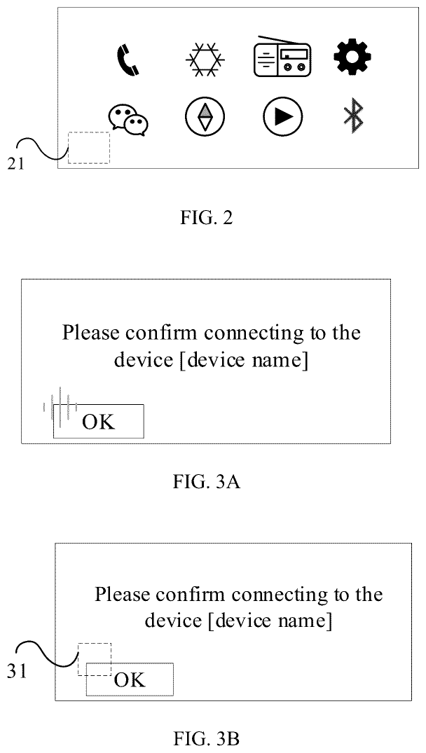

FIG. 2 is a schematic diagram of an initial interface displayed in a vehicle's central control display interface according to some embodiments of the present disclosure.

As shown in FIG. 2, when determining the important information, the application icon display device may obtain an image in the preset display region 21 from the vehicle's initial central control display interface according to the coordinate range of the preset display region 21, and may perform an optical character recognition (OCR) text recognition process on the obtained image to determine whether any text information exists in the preset display region 21.

In some embodiments, if the determination result indicates that the text information exists in the preset display region 21, the application icon display device may directly determine that the important information exists in the preset display region 21, so the current preset display region 21 needs to be horizontally shifted to avoid the text information, thereby preventing the voice icon from blocking user's normal reading of the text information.

On the contrary, if the determination result indicates that no text information exists in the preset display region 21, the application icon display device may further perform an image recognition process on the image in the preset display region 21 to determine an importance of the image. In some embodiments, the image recognition may be implemented by a pre-trained image recognition model. The image recognition model may be a neural network binary classification model based on principles of machine learning. Technicians may use a large number of image samples and their corresponding annotation data to train the image recognition model, such that the image recognition model is capable of determining the importance of the image.

Further, the application icon display device may input the image in the preset display region 21 into the image recognition model to determine its importance. If the image recognition model determines that the image in the preset display region 21 is of high importance, the application icon display device may determine that the important information appears in the preset display region 21, such that the current preset display region 21 needs to be horizontally shifted to prevent the important information of the image from being blocked by the voice icon, thereby affecting the user's normal observation of the important information of the image. Conversely, if the image recognition model determines that the image in the preset display region 21 is of little importance, the application icon display device may determine that no important information appears in the preset display region based on the determination result that no text information pears in the preset display region 21 and the image in the preset display region 21 is of little importance.

Those skilled in the art understand that the above method of using a binary classification model to determine the importance of an image is merely a non-limiting embodiment provided by the present disclosure, which is intended to clearly demonstrate the idea of the present disclosure and to provide a specific scheme for the convenience of the public to implement, and is not intended to limit the scope of the present disclosure.

In some other embodiments, the above-described image recognition may also be implemented based on the number of colors contained in the image and/or the degree of color difference between adjacent pixels. Specifically, the application icon display device may perform a component analysis of RGB three-color channels on each pixel of the image in the preset display region 21 to determine a specific color of each pixel in the image. Further, the application icon display device may collect statistics on the color of each pixel based on the coordinates of each pixel in the image. If a statistical result indicates that the number of colors contained in the image is greater than a preset number threshold, the application icon display device may determine that the image has rich content and high importance, and may further determine that the important information appears in the preset display region 21. Similarly, if the statistical result indicates that the color difference between adjacent pixels in the image is greater than a preset difference threshold, the application icon display device may also determine that the image has rich content and high importance, and may further determine that the important information appears in the preset display region 21. Conversely, if the statistical result indicates that the number of colors contained in the image is less than or equal to the preset number threshold, and the color difference between adjacent pixels is less than or equal to the preset difference threshold, the application icon display device may determine that the image does not have rich content or high importance, and may further determine that no important information appears in the preset display region 21.

As described above, the application icon display device also needs to determine whether to horizontally shift the preset display region 21 according to whether a human machine interface appears in the preset display region 21. The human machine interface includes, but is not limited to, buttons, sliders, access boxes, and other user interface (UI) controls that respond to user operations such as clicking, sliding, and inputting.

In some embodiments, in the initial interface displayed in the vehicle central control shown in FIG. 2, the application icon display device may first obtain a view tree of the initial interface displayed by the vehicle central control of the in-vehicle information system. It should be understood that the initial interface of the central control display interface refers to the initial interface displayed on the central control display interface after the in-vehicle information system is initialized, and is generally designed by the designer of the in-vehicle information system. The view tree is a hierarchical view for displaying various control information in the initial interface of the central control display interface, where all visible controls in the initial interface of the central control display interface are located at leaf nodes of the view tree.

After obtaining the view tree of the initial interface displayed by the central control display interface, the application icon display device may traverse the view tree to determine all operable leaf nodes in the initial interface displayed by the central control display interface. The leaf nodes correspond to phone function controls, air conditioner function controls, radio function controls, configuration function controls, and other system-built-in controls in the initial interface of the central control display interface, as well as WeChat function controls, navigation function controls, multimedia players, Bluetooth function controls, and other third-party controls. The application icon display device may obtain position information and shape information of the operable leaf nodes to determine the coordinate ranges occupied by the operable leaf nodes in the initial interface of the central control display interface. Whether the coordinate ranges occupied by the operable leaf nodes match the coordinate range of the preset display region 21 may be used to determine whether any human machine interface corresponding to the operable leaf nodes appears in the preset display region 21.

As shown in FIG. 2, under normal circumstances, the designer of the voice control program adapted to the vehicle model may clearly understand a layout of the initial interface of the in-vehicle information system, and may adjust the preset display region to avoid the important information and the human machine interfaces such as buttons and input boxes, thereby ensuring the normal display of the important information and the normal use of various functions in the display interface of the in-vehicle information system. Thus, in response to the determination result that neither any important information nor any human machine interface appears in the preset display region 21, the application icon display device may determine the preset display region 21 as a target display region, and display the voice icon in the target display region. In this way, the in-vehicle information system may run the voice control program in the background, and only the voice icon is displayed on the vehicle's central control display interface for the user to control the in-vehicle information system to collect the voice data.

However, the current in-vehicle information system generally adopts an open system structure, and many third-party applications can be installed. Thus, it is difficult for the designers of the vehicle's voice control program to predict information display regions of the third-party applications and positions of the human machine interfaces of all other programs on the market. In some embodiments, when the user further opens other third-party applications, the above-described preset display region 21 will inevitably overlap with the information display regions or the human machine interfaces of some other applications, thereby covering the information display regions and affecting the normal reading of the information by the user, or covering the human machine interfaces and affecting the normal use of the corresponding functions by the user.

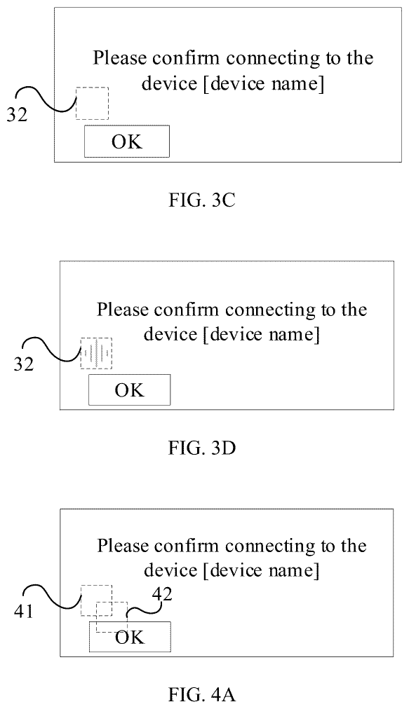

Referring to FIG. 3A to FIG. 3D, FIG. 3A is a schematic diagram of an application icon displayed in a preset display region according to some embodiments of the present disclosure. FIG. 3B is a schematic diagram of a display region after a first adjustment according to some embodiments of the present disclosure. FIG. 3C is a schematic diagram of a display region after a second adjustment according to some embodiments of the present disclosure. FIG. 3D is a schematic diagram of an application icon displayed in a target display region according to some embodiments of the present disclosure.

In some embodiments, the user may open a Bluetooth connection interface by clicking on a Bluetooth function control in the initial interface displayed on the central control display interface to operate a Bluetooth connection to a mobile phone. As shown in FIG. 3A, the Bluetooth connection interface includes an information display box and an “OK” button. The text message “Please confirm connecting to the device [device name]?” is displayed in the information display box, and the coordinate range occupied by the “OK” button coincides with the coordinate range of the preset display region 21 described above. At this time, if the voice icon is still displayed in the preset display region 21, the voice icon will block the “OK” button as shown in FIG. 3A, such that the user is unable to click the “OK” button to confirm the connection to the smart phone.

To solve the above problem, when the central control display interface is switched from the initial interface to the Bluetooth connection interface, the application icon display device may first determine whether the voice control program is in an activated state. In response to the determination result that the voice control program is in the activated state, the application icon display device may determine whether any important information or any human machine interface appears in the preset display region 21 on the Bluetooth connection interface as described above.

As shown in FIG. 3A, the “OK” button appears in the preset display region 21 on the Bluetooth connection interface. Thus, the application icon display device obtains the determination result that the human machine interface appears in the preset display region 21. In response to the determination result, the application icon display device may determine an icon length of the voice icon in an up direction and a down direction according to the previously obtained shape information of the voice icon, and may determine a horizontal (or vertical) shift distance according to the icon length of the voice icon. In some embodiments, the horizontal shift distance may be 0.6 times, 0.8 times, 1 time, 1.2 times, 1.5 times, 2 times, or more of the icon length.

In some embodiments, as shown in FIG. 3B, in an up-down direction, the application icon display device may shift the preset display region 21 upward by 0.6 times the icon length to determine a next display region 31, and may determine again as described above whether any important information or any human machine interface appears in the next display region 31. The specific determination process is the same as the previous embodiments, and will not be repeated herein. Further, in response to the determination result that the important information or the human machine interface appears in the next display region 31, the application icon display device may shift the next display region 31 upward again by 0.6 times the icon length to determine another next display region 32, and may determine again as described above whether any important information or any human machine interface appears in the next display region 32. The process is repeated until neither important information nor human machine interface appears in the next display region 32 as shown in FIG. 3C. At this time, the application icon display device determines the next display region 32 as the target display region, and displays the voice icon of the voice control program in the target display region as shown in FIG. 3D, such that the user can control the in-vehicle information system to collect the voice data.

By designing the horizontal or vertical shift distance to be more than half of the icon length, a step size of the shift operation is effectively increased, such that when the application icon substantially overlaps with the human machine interface or the important information in a large rage as shown in FIG. 3A, only a few times of the shift operation may remove the overlapping of the application icon and the human machine interface or the important information. By designing the shift distance to a value close to half the icon length (e.g., 0.6 times), on one hand, the step size of the shift operation may be reasonably limited to reduce the shift distance of the application icon such that the user is able to find the application icon near a usual or habitual position, on the other hand, in the case that the application icon shown in FIG. 3B overlaps with the human machine interface or the important information in a small range, shifting an excessively long shift distance to cause the application icon to overlap with another important information or another human machine interface again may be avoided, thereby improving a success rate of finding a suitable target display region.

Those skilled in the art should understand that the above solution of obtaining the icon length in the up-down direction of the voice icon and shifting the display region upwards is only a non-limiting embodiment of the present disclosure, which is intended to clearly illustrate the present invention and provide a specific solution that is convenient for the public to implement, but is not intended to limit the scope of the present disclosure.

In some other embodiments, the application icon display device may also obtain the icon length in the up-down direction of the voice icon, and shift the display region downward according to actual needs, thereby achieving a same effect of avoiding the important information or the human machine interface.

In some other embodiments, the application icon display device may also obtain the icon length in a left-right direction of the voice icon, and shift the display region to the left or right according to actual needs, thereby achieving the same effect of avoiding the important information or the human machine interface.

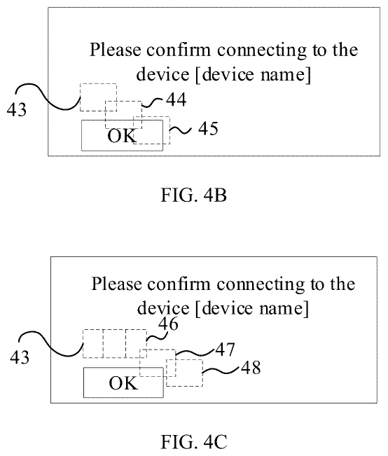

Referring to FIG. 4A to FIG. 4C, FIGS. 4A-4C are schematic diagrams of display region adjustments according to some embodiments of the present disclosure.

In some embodiments, as shown in FIG. 4A, the application icon display device may obtain a first icon length in the up-down direction and a second icon length in the left-right direction of the voice icon at the same time, shift the preset display region 21 upward by a first shift distance (e.g., 0.6 times the first icon length) to determine a first candidate region 41, and shift the preset display region 21 to the right by a second shift distance (e.g., 0.6 times the second icon length) to determine a second candidate region 42.

Further, the application icon display device may determine whether the important information or the human machine interface appears in the first candidate region 41 and/or the second candidate region 42 respectively as described above. As shown in FIG. 4B, in response to the determination result that the human machine interface appears in the first candidate region 41, the application icon display device may shift the first candidate region 41 upward again by the first shift distance (e.g., 0.6 times the first icon length) to determine a third candidate region 43, and may shift the first candidate region 41 to the right again by the second shift distance (e.g., 0.6 times the second icon length) to determine a fourth candidate region 44. Similarly, in response to the determination result that the human machine interface appears in the second candidate region 42, the application icon display device may shift the second candidate region 42 upward again by the first shift distance (e.g., 0.6 times the first icon length) to determine a new candidate region (same position as the fourth candidate region 44 above), and may shift the second candidate region 42 to the right again by the second shift distance (e.g., 0.6 times the second icon length) to determine a fifth candidate region 45.

Further, the device for displaying application icons may determine whether the important information or the human machine interface appears in the third candidate region 43, the fourth candidate region 44, and/or the fifth candidate region 45 respectively as described above. As shown in FIG. 4C, in response to the determination result that neither the important information nor the human machine interface appears in the third candidate region 43, the application icon display device may not perform subsequent shift operations on the third candidate region 43. In response to the determination result that the human machine interface appears in the fourth candidate region 44, the application icon display device may shift the fourth candidate region 44 upward again by the first shift distance (e.g., 0.6 times the first icon length) to determine a sixth candidate region 46, and may shift the fourth candidate region 44 to the right again by the second shift distance (e.g., 0.6 times the second icon length) to determine a seventh candidate region 47. Similarly, in response to the determination result that the human machine interface appears in the fifth candidate region 45, the application icon display device may shift the fifth candidate region 45 upward again by the first shift distance (e.g., 0.6 times the first icon length) to determine a new candidate region (same position as the seventh candidate region 47), and may shift the fifth candidate region 45 to the right again by the second shift distance (e.g., 0.6 times the second icon length) to determine an eighth candidate region 48.

Similarly, the application icon display device may further perform the shift operation on candidate regions (e.g., the candidate region 47) where the important information or the human machine interface appears as described above until none of the candidate regions obtained through the shift operation includes the important information or the human machine interface, or an end of the central control display interface is reached in the up-down direction or the left-right direction.

Further, the application icon display device may scan the candidate regions 41 to 48 based on the appearance of the important information and/or the human machine interface to determine at least one displayable region (i.e., the candidate regions 43, 46, 48). Then, the application icon display device may sort the displayable regions (i.e., the candidate regions 43, 46, 48) according to the distances thereof, and may determine the displayable region (e.g., the candidate region 43) closest to the preset display region 21 as the target display region, such that the voice icon is displayed in the target display region (i.e., the candidate region 43) for the user to control the in-vehicle information system to collect the voice data.

By adopting the above method to obtain multiple candidate regions 43, 46, 48 that can be used to display the application icon and to sort the multiple candidate regions 43, 46, 48 according to the distances thereof, the application icon display device may accurately select the displayable region closest to the preset display region 21 to display the voice icon. By selecting the displayable region closest to the preset display region 21 to display the voice icon, it is convenient for the user to find the required application icon near the usual or habitual position, thereby improving user experience.

Those skilled in the art should understand that although the above embodiments are described based on the automatically activated voice control program, these are only some specific solutions provided by the present disclosure for the convenience of public implementation, and are not intended to limit the scope of the present disclosure. In some other embodiments, the application program may also be activated manually by the user. For example, the user may click a navigation function control on the initial interface displayed on the central control display interface shown in FIG. 2 to activate a navigation program. The navigation program may run in the background of the in-vehicle information system, and only a navigation icon is displayed on the vehicle's central control display interface for the user to control the in-vehicle information system to collect destination information provided by the user. The specific scheme of displaying the navigation icon on the vehicle's central control interface is similar to the above-described scheme of displaying the voice icon, and will not be repeated herein.

Those skilled in the art should also understand that although the above embodiments describe the application icon display device as a virtual device embedded in the vehicle controller and/or other vehicle control modules of the in-vehicle system in the form of program codes, this does not limit the scope of the present disclosure. In some other embodiments, the application icon display device provided by the present disclosure may also include an independent hardware module, which may be mounted on the in-vehicle system through a data line connection to achieve the same control effect.

Those skilled in the art should understand that although the above embodiments describe the implementation of the application icon display method based on the in-vehicle information system, this does not limit the scope of the present disclosure. In some other embodiments, the above-described application icon display method provided by the present disclosure may also be applied to smart phones, tablet computers, and other smart electronic devices, thereby avoiding blocking the important information and/or the human machine interface.

Although the methods described above are illustrated and described as a series of actions for simplicity of explanation, it should be understood and appreciated that the methods are not limited by an order of the actions. According to one or more embodiments, some actions may occur in a different order and/or concurrently with other actions from those illustrated and described herein or not illustrated and described herein but can be understood by those skilled in the art.

Those of skill in the art should understand that information, signals and data may be represented using any of a variety of different technologies and techniques. For example, data, instructions, commands, information, signals, bits, symbols, and chips referenced throughout the above description may be composed of voltages, currents, electromagnetic waves, magnetic fields or particles, optical fields or particles, or any combination thereof.

Those of skill in the art should further appreciate that various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon a particular application and design constraints imposed on the overall system. Those skilled in the art may implement the described functionality in various ways for each particular application, but such implementation decisions should not be interpreted as causing a departure from the scope of the present disclosure.

Although the application icon display device described in the above embodiments may be implemented by a combination of software and hardware, it should be understood that the application icon display device may be implemented in software or hardware alone. For hardware implementation, the application icon display device may be implemented in one or more application-specific integrated circuits (ASICs), digital signal processors (DSPs), programmable logic devices (PLDs), field-programmable gate arrays (FPGAs), processing controllers, microcontrollers, microprocessors, other electronic devices for performing the functions described above, or selected combinations thereof. For software implementation, the application icon display device may be implemented by independent software modules such as program modules (procedures) and function modules (functions) running on a general-purpose chip, where each module may execute one or more functions and operations described in the specification.

The various illustrative logic modules, and circuits described in connection with the embodiments disclosed herein may be implemented using a general-purpose processor, a digital signal processor (DSP), an application-specific integrated circuit (ASIC), a field-programmable gate array (FPGA), or other programmable logic devices, discrete gates or transistor logics, discrete hardware components, or any combination thereof designed to perform the functions described herein. The general-purpose processor may be a microprocessor, but alternatively, the processor may be any conventional processor, controller, microcontroller, or state machine. The processor may also be implemented as a combination of computing devices, e.g., a combination of a DSP and a microprocessor, multiple microprocessors, one or more microprocessors in cooperation with a DSP core, or any other such configurations.

The above description of the present disclosure is provided to enable any person skilled in the art to make or use the present disclosure. Various modifications to the present disclosure will be readily apparent to those skilled in the art, and the generic principles defined herein may be applied to other variations without departing from the spirit or scope of the present disclosure. Thus, the disclosure is not intended to be limited to the examples and designs described herein but is to be accorded the widest scope consistent with the principles and novel features disclosed herein.

1. A method of displaying an application icon of an application program, comprising:
in response to an activation of the application program, determining whether any important information or any human machine interface appears in a preset display region on a display interface;
in response to the important information or the human machine interface being determined to appear in the preset display region, determining whether any important information or any human machine interface appears in a shifted display region on the display interface, and repeating the process of determining a presence of any important information or any human machine interface in the shifted display region until a target display region where neither important information nor human machine interface appears is determined in the display interface; and
displaying the application icon of the application program in the target display region.

2. The method according to claim 1, wherein determining whether any important information or any human machine interface appears in the preset display region on the display interface comprises:
performing a text recognition process on the preset display region to determine whether any text information exists in the preset display region;
in response to no text information being determined to exist in the preset display region, performing an image recognition process on the preset display region to determine an importance of an image of the preset display region;
in response to some text information being determined to exist in the preset display region or the image of the preset display region being determined to be of high importance, determining that important information appears in the preset display region; and
in response to no text information being determined to exist in the preset display region and the image of the preset display region being determined to be of low importance, determining that no important information appears in the preset display region.

3. The method according to claim 2, wherein performing the image recognition process on the preset display region to determine the importance of the image of the preset display region comprises:
collecting statistics on color of each pixel in the image of the preset display region; and
based on a number of colors contained in the image and/or color difference between adjacent pixels in the image, determining the importance of the image of the preset display region.

4. The method according to claim 1, wherein determining whether any important information or any human machine interface appears in the preset display region on the display interface comprises:
traversing a view tree of the display interface to determine all operable leaf nodes in the display interface;
obtaining position information and shape information of the operable leaf nodes; and
based on the position information and the shape information of the operable leaf nodes, determining whether any human machine interface corresponding to the operable leaf nodes appears in the preset display region.

5. The method according to claim 1, wherein after determining whether any important information or any human machine interface appears in the preset display region on the display interface, the method further comprises:
in response to neither any important information nor any human machine interface being determined to appear in the preset display region, determining the preset display region to be a target display region.

6. The method according to claim 1, wherein before determining whether any important information or any human machine interface appears in the preset display region on the display interface, the method further comprises:
obtaining the shape information of the application icon, the shape information including at least one icon length of the application icon in at least one shift direction; and
in response to some important information or some human machine interface being determined to appear in the preset display region, shifting the preset display region in the at least one shift direction by a shift distance to determine a next display region, the shift distance being greater than one half of the icon length.

7. The method according to claim 6, wherein:
obtaining the shape information of the application icon includes obtaining a first icon length of the application icon in a first shift direction and a second icon length of the application icon in a second shift direction; and
shifting the preset display region in the at least one shift direction by the shift distance to determine the next display region includes shifting the preset display region in the first shift direction by a first shift distance to determine a first candidate region and shifting the preset display region in the second shift direction by a second shift distance to determine a second candidate region.

8. The method according to claim 7, wherein repeating the process of determining the presence of any important information or any human machine interface in the shifted display region comprises:
determining whether any important information or any human machine interface appears in the first candidate region and the second candidate region, respectively;
in response to some important information or some human machine interface being determined to appear in any one of the first candidate region and the second candidate region, shifting the corresponding candidate region in the first shift direction by the first shift distance to determine a third candidate region, shifting the corresponding candidate region in the second shift direction by the second shift distance to determine a fourth candidate region, and determining whether any important information or any human machine interface appears in the third candidate region and the fourth candidate region, respectively, until none of the candidate regions includes any important information or any human machine interface, or an end of the display interface is reached in an up-down direction or a left-right direction;
based on the presence of any important information or any human machine interface in any of the candidate regions, scanning each candidate region to determine at least one displayable region; and
determining the at least one displayable region closest to the preset display region to be the target display region.

9. The method according to claim 1, wherein:
the application program is a voice control program, and the application icon is a voice icon of the voice control program.

10. A device of displaying an application icon of an application program, comprising a memory storing computer instructions and a processor coupled to the memory, wherein the processor is configured to execute the computer instructions to:
in response to an activation of the application program, determine whether any important information or any human machine interface appears in a preset display region on a display interface;
in response to the important information or the human machine interface being determined to appear in the preset display region, determine whether any important information or any human machine interface appears in a shifted display region on the display interface, and repeat the process of determining a presence of any important information or any human machine interface in the shifted display region until a target display region where neither important information nor human machine interface appears is determined in the display interface; and
display the application icon of the application program in the target display region.

11. A computer-readable storage medium storing computer instructions, wherein when being executed by a processor, the computer instructions cause the processor to perform:
in response to an activation of an application program, determining whether any important information or any human machine interface appears in a preset display region on a display interface;
in response to the important information or the human machine interface being determined to appear in the preset display region, determining whether any important information or any human machine interface appears in a shifted display region on the display interface, and repeating the process of determining a presence of any important information or any human machine interface in the shifted display region until a target display region where neither important information nor human machine interface appears is determined in the display interface; and
displaying an application icon of the application program in the target display region.

12. The device according to claim 10, wherein when determining whether any important information or any human machine interface appears in the preset display region on the display interface, the processor is further configured to:
perform a text recognition process on the preset display region to determine whether any text information exists in the preset display region;
in response to no text information being determined to exist in the preset display region, perform an image recognition process on the preset display region to determine an importance of an image of the preset display region;
in response to some text information being determined to exist in the preset display region or the image of the preset display region being determined to be of high importance, determine that important information appears in the preset display region; and
in response to no text information being determined to exist in the preset display region and the image of the preset display region being determined to be of low importance, determine that no important information appears in the preset display region.

13. The device according to claim 12, wherein when performing the image recognition process on the preset display region to determine the importance of the image of the preset display region, the processor is further configured to:
collect statistics on color of each pixel in the image of the preset display region; and
based on a number of colors contained in the image and/or color difference between adjacent pixels in the image, determine the importance of the image of the preset display region.

14. The device according to claim 10, wherein when determining whether any important information or any human machine interface appears in the preset display region on the display interface, the processor is further configured to:
traverse a view tree of the display interface to determine all operable leaf nodes in the display interface;
obtain position information and shape information of the operable leaf nodes; and
based on the position information and the shape information of the operable leaf nodes, determine whether any human machine interface corresponding to the operable leaf nodes appears in the preset display region.

15. The device according to claim 10, wherein after determining whether any important information or any human machine interface appears in the preset display region on the display interface, the processor is further configured to:
in response to neither any important information nor any human machine interface being determined to appear in the preset display region, determine the preset display region to be a target display region.

16. The device according to claim 10, wherein before determining whether any important information or any human machine interface appears in the preset display region on the display interface, the processor is further configured to:
obtain the shape information of the application icon, the shape information including at least one icon length of the application icon in at least one shift direction; and
in response to some important information or some human machine interface being determined to appear in the preset display region, shift the preset display region in the at least one shift direction by a shift distance to determine a next display region, the shift distance being greater than one half of the icon length.

17. The device according to claim 16, wherein:
obtaining the shape information of the application icon includes obtaining a first icon length of the application icon in a first shift direction and a second icon length of the application icon in a second shift direction; and
shifting the preset display region in the at least one shift direction by the shift distance to determine the next display region includes shifting the preset display region in the first shift direction by a first shift distance to determine a first candidate region and shifting the preset display region in the second shift direction by a second shift distance to determine a second candidate region.

18. The device according to claim 17, wherein when repeating the process of determining the presence of any important information or any human machine interface in the shifted display region, the processor is further configured to:
determine whether any important information or any human machine interface appears in the first candidate region and the second candidate region, respectively;
in response to some important information or some human machine interface being determined to appear in any one of the first candidate region and the second candidate region, shift the corresponding candidate region in the first shift direction by the first shift distance to determine a third candidate region, shifting the corresponding candidate region in the second shift direction by the second shift distance to determine a fourth candidate region, and determine whether any important information or any human machine interface appears in the third candidate region and the fourth candidate region, respectively, until none of the candidate regions includes any important information or any human machine interface, or an end of the display interface is reached in an up-down direction or a left-right direction;
based on the presence of any important information or any human machine interface in any of the candidate regions, scan each candidate region to determine at least one displayable region; and
determine the at least one displayable region closest to the preset display region to be the target display region.

19. The device according to claim 10, wherein:
the application program is a voice control program, and the application icon is a voice icon of the voice control program.
